(19) United States
(12) Patent Application Publication
(10) Pub. No.: US 2024/0338971 A1
(43) Pub. Date: Oct. 10, 2024

(54) METHOD AND SYSTEM FOR PROVIDING CUSTOMIZED GENERATIVE AI OUTPUT

(71) Applicant: Gregg Donnenfeld, Roslyn, NY (US)

(72) Inventor: Gregg Donnenfeld, Roslyn, NY (US)

(21) Appl. No.: 18/626,815

(22) Filed: Apr. 4, 2024

Related U.S. Application Data
(60) Provisional application No. 63/458,061, filed on Apr. 7, 2023.

(51) Int. Cl. G06V 40/16; G06Q 50/00

(52) U.S. Cl. CPC G06V 40/172; G06Q 50/01; G06V 40/178

(57) ABSTRACT

A method includes determining at least one characteristic of or associated with a user based on facial recognition data of the user, using generative artificial intelligence (AI) to create output for the user based on input from the user, and customizing at least one aspect of the output based on the at least one characteristic. A system is also disclosed.

### CROSS-REFERENCE TO RELATED APPLICATIONS

This application claims the benefit of U.S. Provisional Application No. 63/458,061, filed Apr. 7, 2023, the disclosure of which is incorporated by reference herein in its entirety.

### BACKGROUND

This application relates to artificial intelligence (AI), and more particularly to customizing the output of generative AI.

Generative AI using large language models (LLMs), such as ChatGPT (a trademark of OPENAI OPCO, LLC), has become widely available and is being used for a variety of purposes. The generative capabilities include creating content in a variety of formats, whether for personal, professional or entertainment purposes.

### SUMMARY

A method according to an example embodiment of the present disclosure includes determining at least one characteristic of or associated with a user based on facial recognition data of the user, using generative artificial intelligence (AI) to create output for the user based on input from the user, and customizing at least one aspect of the output based on the at least one characteristic.

In a further embodiment of the foregoing embodiment, the facial recognition data includes one or more images depicting at least the user's face, and the determining includes utilizing an image analysis machine learning algorithm to analyze the one or more images and determine the at least one characteristic from an appearance of the user in the one or more images. The at least one characteristic includes at least one of age, height, gender, race, ethnicity, hairstyle, health status, and religious affiliation.

In a further embodiment of any of the foregoing embodiments, the facial recognition data includes one or more images of at least the user's face. The determining includes determining an identity of the user based on the one or more images and a facial recognition profile that links the identity of the user to an appearance of the user, and utilizing the identity to determine the at least one characteristic from a database of user data.

In a further embodiment of any of the foregoing embodiments, the database of user data includes a database of social media content.

In a further embodiment of any of the foregoing embodiments, the utilizing the identity to determine the at least one characteristic from a database of user data includes determining the at least one characteristic based on social media content from a social media account of an individual that is not the user.

In a further embodiment of any of the foregoing embodiments, the facial recognition data includes one or more images depicting the user's head and face, and the determining includes determining a religious affiliation of the user based on at least one of hair, headwear, or jewelry of the user in the one or more images.

In a further embodiment of any of the foregoing embodiments, the at least one characteristic includes at least one of age and education level of the user, and the at least one aspect includes at least one of vocabulary, grammar, subject matter, speaking style, and writing style of the output.

In a further embodiment of any of the foregoing embodiments, the at least one characteristic includes at least one of age height, weight, sexual orientation, race, ethnicity, dietary preferences, dietary restrictions, musical preferences, interests, geographic location, occupation, and hobbies of the user. The at least one aspect includes content included in the output.

In a further embodiment of any of the foregoing embodiments, the content includes media content to entertain or educate the user, such as news, videos, music, or podcasts.

In a further embodiment of any of the foregoing embodiments, the content includes recommended locations for the user to visit.

In a further embodiment of any of the foregoing embodiments, the at least one characteristic includes one or more areas of sensitivity of the user, and the customizing the at least one aspect includes adding a warning to the output to indicate that the output includes subject matter that involves the one or more areas of sensitivity.

A system according to an example embodiment of the present disclosure includes processing circuitry operatively connected to memory. The processing circuitry is configured to determine at least one characteristic of or associated with a user based on facial recognition data of the user, use generative AI to create output for the user based on input from the user, and customize at least one aspect of the output based on the at least one characteristic.

In a further embodiment of the foregoing embodiment, the facial recognition data includes one or more images depicting at least the user's face; the processing circuitry is configured to utilize an image analysis machine learning algorithm to analyze the one or more images and determine the at least one characteristic from an appearance of the individual in the one or more images; and the at least one characteristic includes at least one of age, height, gender, race, ethnicity, hairstyle, health status, and religious affiliation.

In a further embodiment of any of the foregoing embodiments, the facial recognition data includes one or more images of at least the user's face. To determine the at least one characteristic, the processing circuitry is configured to determine an identity of the user based on the one or more images and a facial recognition profile that links the identity of the user to an appearance of the user, and utilize the identity to determine the at least one characteristic from a database of user data.

In a further embodiment of any of the foregoing embodiments, the database of user data includes a database of social media content.

In a further embodiment of any of the foregoing embodiments, to utilize the identity to determine the at least one characteristic from a database of user data, the processing circuitry is configured to determine the at least one characteristic based on social media content from a social media account of an individual that is not the user.

In a further embodiment of any of the foregoing embodiments, the facial recognition data includes one or more images depicting the user's head and face; the at least one characteristic includes a religious affiliation of the user; and the processing circuitry is configured to determine the religious affiliation based on at least one of hair, headwear, or jewelry of the user in the one or more images.

In a further embodiment of any of the foregoing embodiments, the at least one characteristic includes at least one of age and education level of the user, and the at least one aspect includes at least one of vocabulary, grammar, subject matter, speaking style, and writing style of the output.

In a further embodiment of any of the foregoing embodiments, the at least one characteristic includes at least one of age height, weight, sexual orientation, race, ethnicity, dietary preferences, dietary restrictions, musical preferences, interests, geographic location, occupation and hobbies of the user. The at least one aspect includes content included in the output.

In a further embodiment of any of the foregoing embodiments, the content includes media content to entertain or educate the user, such as news, videos, music, or podcasts.

In a further embodiment of any of the foregoing embodiments, the content includes recommended locations for the user to visit.

In a further embodiment of any of the foregoing embodiments, the at least one characteristic includes one or more areas of sensitivity of the user. To customize the at least one aspect, the processing circuitry is configured to provide a warning to the output to indicate that the output includes subject matter that involves the one or more areas of sensitivity.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE DRAWINGS

FIG. 1 is a schematic view of an example system that provides customized AI output.

FIG. 2 is a flowchart of an example method.

### DETAILED DESCRIPTION

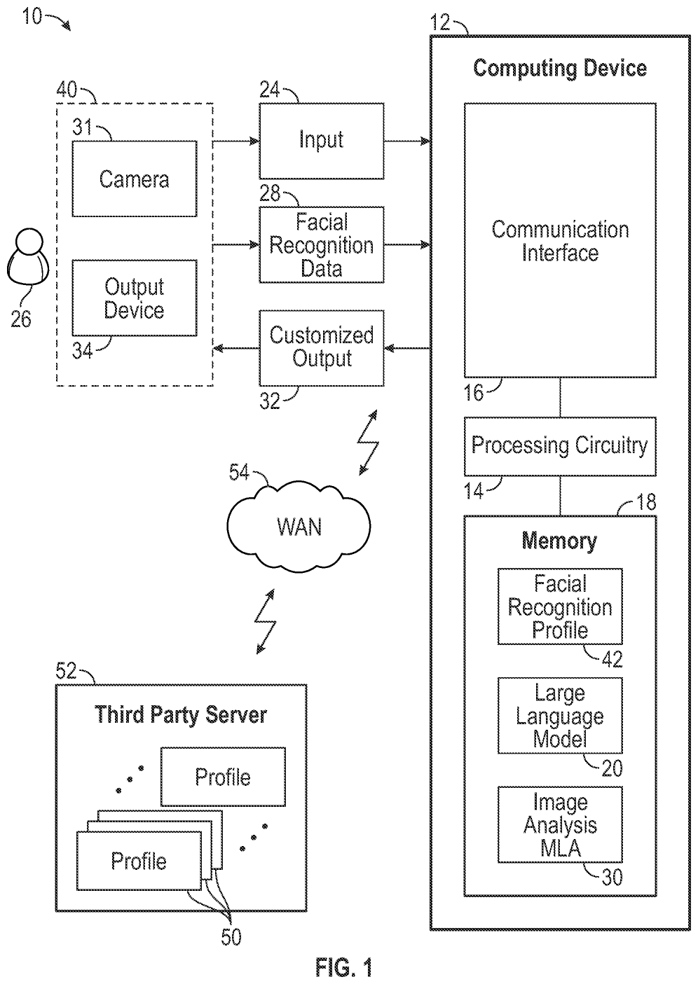

FIG. 1 is a schematic view of an example system 10 that provides customized AI output. The system includes a computing device 12 that includes processing circuitry 14 operatively connected to a communication interface 16 and memory 18. The processing circuitry 14 may include one or more microprocessors, microcontrollers, application specific integrated circuits (ASICs), or the like, for example.

The communication interface 16 is configured to facilitate communication between the computing device 12 and other devices, such as other computing devices and/or peripheral devices (e.g., input devices such as a keyboard, mouse, and/or camera, output devices such as an electronic display, etc.). The communication interface 16 may utilize wired and/or wireless communication for communicating with computing devices and/or peripheral devices.

The memory 18 can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory 18 may incorporate electronic, magnetic, optical, and/or other types of storage media.

Although the processing circuitry 14, communication interface 16, and memory 18 are depicted as residing in a single computing device 12 in FIG. 1, it is understood that this is only an example, and that the processing circuitry 14, communication interface 16, and/or memory 18 may be distributed across a plurality of computing devices, with a distributed architecture in which various components are situated remotely from one another, but can be accessed by each other.

The memory 18 stores a large language model (“LLM”) 20 that includes one or more neural networks, and is configured to use generative artificial intelligence (AI) to generate responses (e.g., text) to input 24 (e.g., requests 24 for information) from a user 26 in a generally known manner. The input 24 may be requests for a wide variety of content, such as educational and/or entertainment content, for example, or may be just some non-request input (e.g., “Hello” or “I am bored” or “I am excited”). The non-request input may be interpreted by the computing device 12 as having an associated implicit request (e.g., “Hello” may be interpreted as an implied request for feedback and/or conversation, “I am bored” may be interpreted as an implied request ideas for entertainment, and “I am excited” may be interpreted as an implicit request for ideas of how to celebrate being in an excited mood).

Some example requests for information may include one or more of the following, for example: “what is the news?”, “how does photosynthesis work?”, “what is Einstein's theory of relativity?”, “please write me a poem about a sunny day”, etc. Some example requests for recommendations may include requests for one or more of the following, for example: places to travel to, restaurants to eat at, movies to watch, books to read, music to listen to, podcasts to listen to, etc.

The computing device 12 receives facial recognition data 28 for a user 26, such as an image recorded by camera 31, and utilizes an image analysis machine learning algorithm (“MLA”) 30 to determine at least one characteristic of or associated with a user 26 based on the facial recognition data 28. The LLM 20 uses generative AI to create output for the user 26, and to customize the output based on the at least one aspect (and thereby provide customized output 32). The customized output 32 is provided to the user 26 through an output device 34, such as a speaker or electronic display (e.g., LCD screen). The customized output may be written, audible, video, or image format, for example.

In one or more embodiments, the computing device 12 is a server, and the camera 31 and output device 34 are part of a computing device 40 that is remote from the server. In one or more further embodiments, the computing devices 12 and 40 are the same device.

In one or more embodiments, the facial recognition data 28 is received along with each set of input 24 from the user 26. In one or more further embodiments, the facial recognition data 28 is received and stored for future input 24 (e.g., in facial recognition profile 42), such that facial recognition data from the user 26 can be omitted from future input 24, but can still be linked with the user 26 (e.g., through a username of the user 26, IP address of the user, etc.).

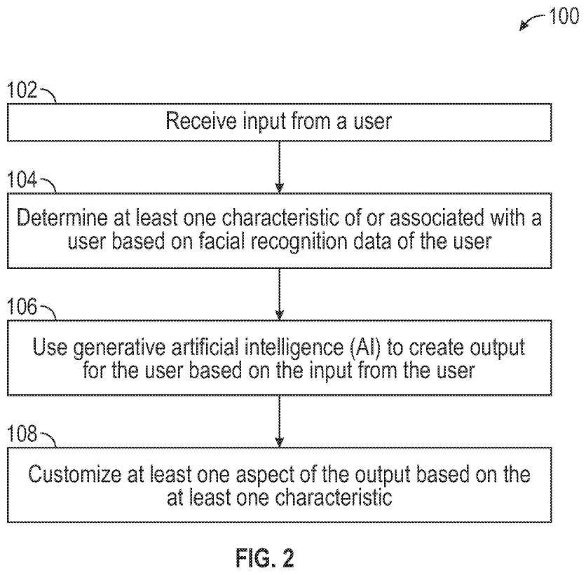

Referring now to FIG. 2, with continued reference to FIG. 1, a flowchart of a method 100 is depicted. The method 100 includes receiving input 24 from the user 26 (step 102), determining at least one characteristic of or associated with the user 26 based on facial recognition data 28 of the user 26 using known facial recognition techniques (step 104), using generative AI to create output for the user 26 based on the input 24 from the user 26 (step 106), and customizing at least one aspect of the output based on the at least one characteristic (step 108) to provide customized output 32.

Although steps 104 and 106 are illustrated separately, it is understood that these steps may be performed together such that the output is generated in its customized form, and such that the method 100 does not require the output to first be generated in a non-customized form and then be separately customized after its generation.

As discussed above, the input 24 may be an explicit request, or may be general input (e.g., which the computing device 12 may interpret as being an implied request). Thus, although requests are discussed in detail here as a form of input 24, it is understood that the present disclosure is not limited to providing the customized output 32 for explicit requests, and that the customized output 32 can be provided in response to general input as well.

The facial recognition data 28 includes one or more images depicting at least the face of the user 26, and may also include the user's entire head and/or neck (e.g., the user's ears, hair, headwear, neck, head jewelry such as necklace or earrings, etc.). The computing device 12 determines the at least one characteristic of or associated with the user 26 based on an appearance of the user 26 in the one or more images.

In one or more embodiments, the determining of step 104 includes utilizing image analysis MLA 30 to analyze he one or more images of the user 26 and determine the at least one characteristic from an appearance of the user 26 in the one or more images. Some example characteristics that may be determined from the facial recognition data itself may include one or more of the following:
age;
height;
gender;
weight
race;
hairstyle
health status;
ethnicity; and
religious affiliation.

The image analysis MLA 30 is trained using historical data to recognize such characteristics based on the appearance of other individuals in the one or more images. Age, for example, may be determinable in part by things such as wrinkles, gray/white hair, lack of hair, etc. Race and/or ethnicity may be determined at least partially based on skin tone and/or facial features.

Religious affiliation may be based on jewelry (e.g., user 26 is likely a Christian if wearing a cross), headwear (e.g., user 26 is likely Jewish if wearing a yarmulke, is likely Muslim if wearing a hijab or taqiyah/topi, etc.), and/or hair (e.g., user 26 is likely an Orthodox Jew if they wear their hair with “payot” sidelocks”).

Thus, as used herein, “facial recognition data” is not limited to recognition of only the eyes/nose/mouth of a un individual, but may also include the individual's head in addition to just their face (e.g., ears, hair, jewelry visible from the user's head/neck (necklace, earrings, etc.), and headwear (e.g., hat, headscarf, etc.)).

Health status may be determined based on appearance as well. For example, if a user 26 wears clear glasses, the computing device 12 may infer that the user 26 is visually impaired. If the user 26 has a cloudy eye appearance, the computing device 12 may infer that the user 26 is blind in the cloudy eye.

The at least one characteristic of or associated with the user 26 may also include some items which are not determined based on facial recognition data alone. In one or more such embodiments, the determining of step 104 includes determining an identity of the user 26 based on the one or more images of the user 26 and the facial recognition profile 42 that links the identity of the user 26 to the appearance of the user 26, and utilizing the identity to determine the at least one characteristic from a database of user data.

The database may be a database of social media content for example, and may be stored on the computing device 12 or a different server (e.g., third party server 52) in the form of profiles 50 (e.g., social media profiles), and may retrievable by the computing device 12 over a wide area network 54, such as the Internet). It is understood, however, that social media data is a non-limiting example, and that other types of data could be used (e.g., marriage records of the user 26, philanthropic giving history of the user 26, property ownership of the user 26, media articles about the user 26 and/or that quote the user 26, etc.).

Some examples of characteristics that may be determined based in part on user 26 appearance and further based on a database of user data may include any one or more of:
sexual orientation;
hobbies;
likes/dislikes;
musical preference/taste;
places where the user 26 has traveled;
where the user 26 lives;
education level and/or schools attended;
employment history;
occupation;
professional achievements;
marital status;
parental status;
social connections;
dietary preferences (e.g., paleo diet);
dietary restrictions (e.g., allergies);
relatives;
geographic location (e.g., current location of the user 26, locations previously lived at by the user 26, and/or locations previously visited by the user 26);
languages spoken by the user 26; and
computer literacy.

For example, if the user 26 appears to be a female with a masculine appearance (e.g., masculine haircut), or a male with a feminine appearance, and their input 24 and/or social media profile 50 indicate support and/or interest in LGBT culture or issues, the computing device 12 may infer a sexual orientation of the user based on that additional information beyond the facial recognition data 28.

As another example, if the user 26 requests a place to for a romantic dinner, and the computing device 12 is able to determine based on profile 50 that the user 26 is married, the customized output 32 may indicate that “a nice place for you and your wife to enjoy dinner is . . . ”). The determination that the user 26 is married may be based on the user's own social media profile 50 indicating they are married, or the user 26 appearing in a photograph of a social media profile 50 of a third party who says they are married and the user 26 appears in one or more photographs of that married person's profile.

Thus, in one or more embodiments, utilizing the identity of the user 26 to determine the at least one characteristic from the database of user data includes determining the at least one characteristic based on social media content from the user's own profile, or from a social media account of an individual that is not the user 26 (e.g., an individual who mentions the user 26 in the individual's social media content).

In one example, if the user 26 has indicated a “like” for a vegetarian advocacy organization on social media, the LLM 20 infers that the user 26 may be vegetarian and customizes the customized output 32 based for vegetarians (e.g., recommending a vegetarian restaurant).

The LLM 20 may be configured to customize the customized output 32 in a variety of different ways. In one or more embodiments, the LLM 20 customizes the customized output 32 by adjusting the vocabulary, grammar, speaking style, and/or writing style of the customized output. In this manner, less sophisticated and/or less complex language (e.g., simpler words and simpler grammar) may be used for children and/or those with lower education levels, and more sophisticated and/or more complex language (e.g., more complex words and more complex grammar) may be used for adults and/or those with higher education levels. The style could be associated with the use or non-use of slang, for example.

In one or more embodiments, the LLM 20 generates output on behalf of the user 26 that is customized to correspond to a voice or style of the user 26. For example, a young child writes or speaks differently than a university professor and the voice or style of the customized output generated on behalf of the former is different than the voice or style of customized output generated on behalf of the latter. Other example ways in which individuals differ may be used for customizing the generated output including gender, age, ethnicity, occupation, or geographic location. Such characteristics may be recognizable by the computing device based on the facial recognition data or be available in a stored profile of the user 26 (e.g., facial recognition profile 42), which is retrieved by the computing device 12 based on the facial recognition results.

In one or more embodiments, if the LLM 20 generates written content for the user 26 to read, that content is tailored to a style or level of complexity that the LLM 20 selects based on at least one characteristic of the user 26. For example, the voice or style that the individual expects to observe when receiving a communication from another person corresponds to that voice or style.

Here is an example application for a technical inquiry (e.g., how to solve a problem with a smartphone). The customized output 32 may:
provide a less sophisticated answer to a child or someone with limited education (high-school dropout) or person above certain age (who is likely less computer literate); and
provide a more sophisticated answer to a person of a certain age (who likely grew up using technology) or to a person with a science/computer degree.

Another example form of customization is in the sophistication and/or complexity of subject matter, such as the level of detail provided. For example, if a user asks “how does photosynthesis work?” then the customized output may be less complex (e.g., “it is the process by which plants use sunlight to create food” or more complex (e.g., giving out extensive scientific/biological information about the process). Here too, this could be customized based on age and/or education level of the user 26.

Another example form of customization is adjusting the relative formality/informality of language used. For example, whether slang terms be used (e.g., “ghosted”) or whether their more formal equivalent be used (e.g., “abandoned”). The same is true of idiom expressions (e.g., should the customized output 32 say “good luck” or “go break a leg”). This type of customization could be particularly relevant to generating content to be provided to the user 26 from a chatbot. If a person is younger, then less formal language may be preferred by the user 26, whereas if they are older then more formal language may be preferred.

Another example form of customization is the extent to which content filtering is performed. Some content may be less appropriate for younger users (e.g., sexual material or graphic descriptions of crimes) but may be more appropriate for younger users. Also, some content may be offensive to certain groups (e.g., a religious user 26 may be offended by seeing certain content that may otherwise not offend most non-religious users). The LLM 20 may customize the extent to which content filtering is performed based on age and/or other criteria, such as religiousness and/or political preferences.

Here is another example way in which content filtering and language complexity/sophistication this may be applied to a request for information about a violent event (e.g., a battle in a war):
if the user 26 is a child is a child, give a less sophisticated answer and/or filter some explicit content (e.g., description of violence, graphic war crimes);
if the user 26 is an adult with limited education (e.g., high school dropout), give a less sophisticated answer (in terms of grammar and vocabular) without filtering for explicit content; and
if the user 26 is an adult with a college education, provide a sophisticated answer (in terms of detail and grammar/vocabulary) without filtering explicit content.

Another example form of customization that may be utilized by the LLM 20 is the extent to which user sensitivities are accommodated. Younger generations are more accustomed to having so-called “trigger warnings” provided before certain material is discussed, with the goal of avoiding the triggering of a strong emotional response associated with certain material (e.g., if the user 26 has been sexually assaulted in the past, they may be particularly sensitive to any discussion of that topic and may appreciate the providing of a warning about such content before being presented with the content). If the user 26 is known to the LLM 20 to have sensitivity for a particular type of content, then the LLM 20 is in one example more likely add a trigger warning to the customized output 32 for that user 26 (and particularly for users of a younger demographic accustomed to receiving such warnings) that involves that content, and is less likely to provide a trigger warning for such content to users without such a sensitivity and/or who are older and less accustomed to receiving such warnings.

Another example form of customization that may be utilized by the LLM 20 is the providing of cultural references. The LLM 20 may select which cultural references to include in the customized output 32 based on the age of the user 26, so that the cultural references are most likely to be relevant to the user 26. Since cultural references vary greatly by decade and by generation, ensuring that a cultural reference is appropriate for the user's age and/or demographic can improve the relevance of the output for that user.

In one or more embodiments, the facial recognition profile 42 links a visual appearance of the user 26 to an identity of the user 26, thereby enabling the computing device 12 to look up additional information about the user from one or more third party servers 52 via a wide area network 54 (e.g., the Internet). This may include determining information the profile 50 may be a social media profile that indicates a geographic area, interests, education level, occupation, professional achievements, marital status, parental status, etc. of the user 26.

Although the third party server 52 has been discussed above as being potentially a source of social media content, it is understood that this is a non-limiting example, and that other types of non-social media content could be used (e.g., philanthropic giving of the user 26, property ownership of the user 26, media articles about the user 26 and/or that quote the user 26, etc.).

While some LLM input 24 may include requests having a straightforward answer, other requests may be more open-ended, such as a request for recommendations (e.g., of locations to visit or media to entertain the user 26). In one or more embodiments, the at least one aspect of the customized output 32 that is customized is the content included in the output, which may be customized based on any of the various characteristic mentioned above. Below are some example requests and ways in which the LLM 20 may customize the content provided in the customized output 32:
Request for a restaurant:
   exclude steakhouse restaurant recommendation for vegetarian;
   exclude bar recommendation for alcoholic or those under 21 years of age (or who appear to be under 21 years of age); and/or
   exclude jazz club recommendation for someone that dislikes jazz music.
Customize recommendations based on perceived interest:
   suggest a gay bar to person who is gay over a non-gay bar;
   suggest an African American History Museum to African American;
   suggest an ethnic restaurant or grocery store of a particular ethnicity to someone who appears to be of the particular ethnicity or likes traveling to country corresponding to the particular ethnicity (e.g., India); and/or
   suggest music record stores to people that like buying music/records.
Avoid recommendations likely to offend a user:
   if a user requests a good comedy movie to watch and they are religious, avoid recommendations likely to offend the person;
   if a person likes fine dining, do not recommend a fast food restaurant to that person.
For determining topics of interest for responding to an inquiry (such as an inquiry for news/current events), the customized output 32 may be customized based on occupation, hobbies, interests, ethnicity, race, and/or geographic locations visited by the individual. Here is an example application of this:
   provide legal news to a lawyer;
   sports news to a sports enthusiast;
   political news to someone who is a politics enthusiast; and/or
   provide news for a particular geographic region (city, state, country) to someone who has lives, has lived, has family, or likes to travel to that area.

In one or more embodiments, the at least one characteristic includes at least one of age and education level of the user 26, and the at least one aspect of the customized output 32 that is customized includes one or more of level of complexity of language, subject matter included in the customized output 32, speaking/writing style of the customized output 32 (e.g., formal language or informal language, which may include slang), that is provided in the output.

In one or more embodiments, the computing device 12 uses the facial recognition data 28 to identify a user 26, uses data from third party server 52 to identify social media connections of the user 26, and customizes the customized output 32 based on the user's connections. For example, if the user 26 has one or more social media contacts that are leaving favorable reviews for a restaurant, the LLM 20 may recommend that restaurant to the user 26.

Embodiments of the present disclosure include the ability to customize an output created using generative AI based on at least one characteristic of an individual. Facial recognition data provides information that corresponds to the characteristic in some embodiments. The customized output may have a voice or style that corresponds to a voice or style of or selected by the individual. The customized output may vary depending on the particular instance. Example outputs are presented in at least one of written, audible, video, or image format.

An example embodiment of a system is configured to generate customized output for an individual. A computing device includes or runs a large language model (LLM) that is configured to generate output, such as text, in a generally known manner. An identification device is configured to determine at least one characteristic of or associated with an individual. In this example, the identification device includes a camera and processing circuitry configured to perform facial recognition using image data from the camera. The facial recognition may be accomplished in a known manner.

The computing device may use information from the identification device to determine at least one characteristic of the individual that is used to influence or customize AI-generated output. The characteristic may be, for example, an identity of the individual based on a match between previously stored facial recognition data and image data from the camera. When the computing device has predetermined information regarding the individual stored in association with the individual's identity, that information may be used to influence how the LLM generates output on behalf of or for the individual.

As can be appreciated from the examples mentioned above, the LLM generates custom output in two directions; to or for the user 26 on the one hand and from or on behalf of the user 26 on the other hand. That way, the generated output intended for the user 26 has a style or voice that is desired by or pleasing to the user 26 and generated output that the user 26 intends to be received or observed by someone else has a voice or style that is consistent with the preference or personality of the individual. Using known facial recognition techniques, the computing device is able to determine who the user 26 is or at least one characteristic of the user 26 and control how the LLM customizes the output based on that determination.

Although the term “user” appearance extensively above, it is understood that the customized output 32 may be customized for other individuals besides the user 26 that submits the input 24 (e.g., the customized output 32 is customized based on the appearance of the user 26 but the input 24 comes from some individual that is different from the user 26 but who submitted the input 24 on behalf of the user 26).

The techniques discussed herein provide substantial improvements for the delivery of content from an LLM, by maximizing the utility of the content to the recipient, and maximizing the likelihood that the content will be delivered in a manner preferred by the recipient.

Although example embodiments have been disclosed, a worker of ordinary skill in this art would recognize that certain modifications would come within the scope of this disclosure. For that reason, the following claims should be studied to determine the scope and content of this disclosure.

What is claimed is:

1. A method, comprising:
determining at least one characteristic of or associated with a user based on facial recognition data of the user;
using generative artificial intelligence (AI) to create output for the user based on input from the user; and
customizing at least one aspect of the output based on the at least one characteristic.

2. The method of claim 1, wherein:
the facial recognition data comprises one or more images depicting at least the user's face;
the determining comprises utilizing an image analysis machine learning algorithm to analyze the one or more images and determine the at least one characteristic from an appearance of the user in the one or more images; and
the at least one characteristic includes at least one of age, height, gender, race, ethnicity, hairstyle, health status, and religious affiliation.

3. The method of claim 1, wherein:
the facial recognition data comprises one or more images of at least the user's face; and
the determining comprises:
determining an identity of the user based on the one or more images and a facial recognition profile that links the identity of the user to an appearance of the user; and
utilizing the identity to determine the at least one characteristic from a database of user data.

4. The method of claim 3, wherein the database of user data comprises a database of social media content.

5. The method of claim 3, wherein the utilizing the identity to determine the at least one characteristic from a database of user data comprises determining the at least one characteristic based on social media content from a social media account of an individual that is not the user.

6. The method of claim 1, wherein:
the at least one characteristic comprises at least one of age and education level of the user; and
the at least one aspect comprises at least one of vocabulary, grammar, subject matter, speaking style, and writing style of the output.

7. The method of claim 1, wherein:
the at least one characteristic comprises at least one of age height, weight, sexual orientation, race, ethnicity, dietary preferences, dietary restrictions, musical preferences, interests, geographic location, occupation, and hobbies of the user; and
the at least one aspect comprises content included in the output.

8. The method of claim 7, wherein the content comprises media content to entertain or educate the user.

9. The method of claim 8, wherein the content comprises news, videos, music, or podcasts.

10. The method of claim 7, wherein the content comprises recommended locations for the user to visit.

11. The method of claim 1, wherein:
the at least one characteristic comprises one or more areas of sensitivity of the user; and
the customizing the at least one aspect comprises adding a warning to the output to indicate that the output includes subject matter that involves the one or more areas of sensitivity.

12. A system, comprising:
processing circuitry operatively connected to memory and configured to:
determine at least one characteristic of or associated with a user based on facial recognition data of the user;
use generative AI to create output for the user based on input from the user; and
customize at least one aspect of the output based on the at least one characteristic.

13. The system of claim 12, wherein:
the facial recognition data comprises one or more images depicting at least the user's face;
the processing circuitry is configured to utilize an image analysis machine learning algorithm to analyze the one or more images and determine the at least one characteristic from an appearance of the individual in the one or more images; and
the at least one characteristic includes at least one of age, height, gender, race, ethnicity, hairstyle, health status, and religious affiliation.

14. The system of claim 12, wherein:
the facial recognition data comprises one or more images of at least the user's face; and
to determine the at least one characteristic, the processing circuitry is configured to:
determine an identity of the user based on the one or more images and a facial recognition profile that links the identity of the user to an appearance of the user; and
utilize the identity to determine the at least one characteristic from a database of user data.

15. The system of claim 14, wherein the database of user data comprises a database of social media content.

16. The system of claim 12, wherein:
the at least one characteristic comprises at least one of age and education level of the user; and
the at least one aspect comprises at least one of vocabulary, grammar, subject matter, speaking style, and writing style of the output.

17. The system of claim 12, wherein:
the at least one characteristic comprises at least one of age height, weight, sexual orientation, race, ethnicity, dietary preferences, dietary restrictions, musical preferences, interests, geographic location, occupation, and hobbies of the user; and
the at least one aspect comprises content included in the output.

18. The system of claim 17, wherein the content comprises media content to entertain or educate the user.

19. The system of claim 17, wherein the content comprises recommended locations for the user to visit.

20. The system of claim 12, wherein:
the at least one characteristic comprises one or more areas of sensitivity of the user; and
to customize the at least one aspect, the processing circuitry is configured to provide a warning to the output to indicate that the output includes subject matter that involves the one or more areas of sensitivity.
